(19) United States
(12) Patent Application Publication
(10) Pub. No.: US 2024/0009761 A1
(43) Pub. Date: Jan. 11, 2024

(54) Device and Method for Determining a Focal Point

(71) Applicant: Primes GmbH Messtechnik für die Produktion mit Laserstrahlung, Pfungstadt (DE)

(72) Inventors: Reinhard Kramer, Pfungstadt (DE); Otto Märten, Dreieich (DE); Stefan Wolf, Groß-Gerau (DE); Johannes Roßnagel, Mainz-Kastel (DE); Marc Hänsel, Darmstadt (DE); Roman Niedrig, Berlin (DE)

(21) Appl. No.: 18/257,461

(22) PCT Filed: Dec. 14, 2021
(86) PCT No.: PCT/EP2021/085618

§ 371 Date: Jun. 14, 2023

(30) Foreign Application Priority Data
Dec. 18, 2020 (DE) 102020134317.5

(51) Int. Cl. B23K 26/046; B23K 26/064; B23K 26/035

(52) U.S. Cl. CPC B23K 26/046; B23K 26/064; B23K 26/035

(57) ABSTRACT

The invention relates to a beam analysis device (10) for determining the axial position of the focal point (71) of an energy beam or a sample beam (70) decoupled from an energy beam, comprising a beam-shaping device (12), a detector (40), and an analysis device (45). The beam-shaping device (12) is designed to modulate an intensity distribution (81) of the energy beam (77) or the decoupled sample beam (70) on a modulation plane (19) using a two-dimensional transmission function in order to form a modulated sample beam (79). The transmission function has at least two contrast stages (32, 33) with a distance a to each other in the form of transitions between at least one blocking region (25) and at least one passage region (21). The beam-shaping device (12) is designed to guide the modulated sample beam (79) onto the detector (40) along a propagation path in order to form the intensity distribution (83) on the detector (40) with at least two contrast features (92, 93) along the first lateral direction (31). The analysis device (45) is designed to determine the distance a along the first lateral direction (31) between positions of the contrast features (92, 93) on the detector (40) and to determine the axial position of the beam focus (71) on the basis of the distance a and/or to determine a change in the axial position of the beam focus (71) on the basis of a change in the distance a. The invention also relates to a corresponding method for determining the axial position of a beam focus (71).

### FIELD OF THE INVENTION

The invention relates to a device and a method for determining the axial position of a beam focus of an energy beam of electromagnetic radiation, in particular, for determining the axial position of a beam focus of processing optics. In particular, the energy beam can be a laser beam. The invention also provides devices and methods, which enable a determination of the position of the beam focus of processing optics during a laser processing operation.

### Background of the Invention

A central task in laser material processing is the adjustment and control of the axial focal position of the laser beam relative to the material or workpiece to be processed. With optimal process control, the focus of the laser beam is not necessarily directly on the surface of the workpiece. Rather, the optimal positioning of the laser beam focus relative to the workpiece depends on a plurality of factors. For example, the focus can lie within the workpiece, that is to say, below the workpiece surface, in particular when processing workpieces with a high material thickness. Often the processing result is sensitively dependent on the exact focal position of the laser beam, which is why it is desirable or necessary that the positioning of the laser beam focus with respect to the workpiece does not alter during processing.

In laser cutting processes, it is also important that the distance between the workpiece and the cutting nozzle remains as constant as possible during the processing, as the flow dynamics of the cutting gas have a great influence on the cutting result. This problem can, for example, be solved in a manner of known art by means of capacitive distance measurement and closed loop control.

Often the problem of altering the beam focal position relative to the workpiece is not the detection or tracking of the workpiece position or the workpiece distance relative to the processing optics, but rather the detection of the actual beam focal position relative to the processing optics.

Modern laser processing systems use lasers with a high brilliance and a high power, often in the region of several kilowatts. Due to the material properties in the optical elements of laser processing optics, the high laser power causes the optical elements to heat up. This creates a radial temperature gradient in the optical elements, which results in an alteration of the refractive power of the optical elements due to the temperature dependence of material parameters such as the refractive index. This effect is called a thermal focal shift. Although the said thermal focal shift can be minimised by choosing suitable materials for the optical elements, for example by using high-purity, low-absorption types of quartz glass, it is still virtually always present. The effect is intensified by the reaction products and particles of various sizes produced during the laser material processing; these can deposit on the processing optics, or the protective glass of the processing optics, and lead to increased absorption. Thus, the protective glass, in particular, often contributes to an alteration of the beam focal position of the processing optics.

Devices for determining a workpiece distance or a workpiece surface position are of known art from the prior art; these function, for example, in accordance with the basic principle of optical triangulation.

For example, the patent application EP 0 248 479 A1 discloses an arrangement for the optical measurement of a distance between a surface and a reference surface. For this purpose, the surface is illuminated with a radiation source and the reflected radiation is directed via an optical system onto a detector, after the reflected radiation has passed through a screen with two off-axis openings. The extent of the pattern of beam spots produced by the screen is a measure of the distance between the surface and the reference surface.

The distance measurement method disclosed in the patent no. DE 42 06 499 C2 functions in a very similar manner. Here, too, the light emitted by an object is guided through a screen with off-axis openings and directed onto a measuring head. The special feature here is that to avoid speckle structures, which can affect the accuracy of the measurement, only a fraction of the incoherent radiation of a luminous spot is used; the object is excited to the emission of this radiation by irradiation with electromagnetic radiation.

From the patent application DE 10 2013 210 078 A1 a device and a method for determining the focal position of a high-energy beam are of known art. The device comprises, amongst other items, an image acquisition device which is designed to form at least two observation beams, and imaging optics for the generation of at least two images of the region to be monitored or a reference contour. On the one hand, an alteration of the lateral distance between the two images of the area to be monitored of the workpiece surface can be used to infer a deviation of the focal position relative to the workpiece. On the other hand, an alteration of the focal length of the focusing element can be determined from an alteration of the lateral distance between two images of the reference structure, which can be formed by the inner contour of a laser processing nozzle, for example, and thus an alteration of the focal position can be inferred. Since the light emitted or reflected by the workpiece or the reference structure is also used in this device to generate the images, it is not possible to measure the focal position of the high-energy beam in the strict sense. An alteration of the beam focal position, which is not caused by the focusing element, but instead, for example, by the collimation optics, would not be able to be determined with the disclosed device.

The patent application EP 2 886 239 A1 discloses a method and a device for monitoring and controlling the processing path in a laser joining process. The processing head described in the publication has, amongst other items, a distance sensor in the form of a double slit sensor with imaging optics and a double slit screen. The distance sensor can be used to determine the distance between the processing head and the workpiece surface.

In all the publications cited above, a position or a distance of a workpiece surface is ultimately always determined optically. The determination of the focal position of a beam directed onto a workpiece surface, on the other hand, is not possible with the devices and methods cited above, or only with a low accuracy. In order to be able to determine the actual focal position of the processing beam, it is necessary to measure the processing beam directly, or to decouple a sample beam from the processing beam, and measure the sample beam.

The patent application DE 10 2017 215 973 A1 describes a device and a method for determining the beam position of a laser beam. For this purpose, a secondary beam is decoupled from the laser beam by means of a beam splitter, and is directed onto a position sensor. A beam shaper is arranged in the beam path of the secondary beam, or in front of the beam splitter. The device is designed to determine the beam position of the laser beam from the intensity distribution of the shaped secondary beam detected by the optical position sensor, or from the position of the focus of the shaped secondary beam. The device serves to detect a beam position error of a laser beam. Likewise, a deviation of the diameter of the laser beam can be detected. Thus, the device is designed to detect beam position errors and deviations that manifest themselves in transverse, that is to say, radial or lateral, alterations. The determination of an axial focal position of the laser beam is not envisaged.

A device and a method for the processing of material with electromagnetic radiation are of known art from the publication WO 2012/041 351 A1. Her it is envisaged that a device for pattern generation, for example a shadow mask, is swivelled into the electromagnetic beam, which is focussed on the material. A partially reflecting surface is arranged in front of the focus, so that the image of the pattern generated with the pattern generator is reflected back onto the partially reflecting surface and reaches a detector via a beam splitter. The image on the detector is processed by a computer, and an electrical signal that is a function of the focal position is generated. The disclosed method is intended for use in ophthalmic surgery. However, the method is not suitable, or not very suitable, for general applications in laser material processing, since in general it is not possible to arrange a partially reflecting surface permanently just in front of the beam focus, and it is also not favourable to arrange a shadow mask in a high-power laser beam.

In the device for monitoring a laser beam that is disclosed in WO 2015/185 152 A1, radiation is reflected back by means of a plane plate arranged at a tilt angle in the laser beam, and is detected with a spatially resolving detector. Alterations in the divergence of the laser beam can be determined by detecting a shift in the focal position of the sub-beam imaged onto the detector. The device is in particular intended for analysing and monitoring a driver laser arrangement for the generation of EUV radiation.

The patent application DE 10 2011 007 176 A1 describes a device for focusing a laser beam and a method for monitoring laser processing. For this purpose, laser radiation is reflected back from a transmissive optical element, in particular from a protective glass, and the back-reflected radiation is detected by a detector so as to determine the focal position. Here the protective glass is arranged at a tilt angle so that the back-reflected radiation is deflected directly to the side, and no further beam splitting is required. A screen is provided to block out the back-reflected radiation from one of the sides of the protective glass. The focal position of the laser beam is determined by evaluating the size, that is to say, the diameter, of the region of impingement of the back-reflected laser radiation on the detector.

The patent DE 10 2013 227 031 A1 discloses a device and a method for purposes of analysing a light beam incident on a substrate, and for correcting a focal length shift. In the device shown, a component of the light beam reflected by the protective glass is deflected into a measuring beam path onto a sensor for purposes of beam analysis. The component reflected from the protective glass is guided through a screen in the measuring beam path, as a result of which interference beams reflected from other parts of the device are masked out. In order to achieve the desired interference beam masking, an inclination of the protective glass, and/or the use of wedge plates to deflect the reflected beam, is envisaged. As a sensor, the publication instructs the use of a CCD camera or a CMOS camera, with which a measurement in accordance with DIN ISO 11146 is to be enabled. Furthermore, the determination of the actual focal length by means of ABCD matrix calculation is envisaged.

The device and method presented in the patent application DE 10 2018 105 364 A1 for purposes of determining a focal position of a laser beam in a laser processing system operate in a very similar manner to the device from DE 10 2011 007 176 A1. In the method of DE 10 2018 105 364 A1, the use of calibration data, which comprise beam diameters measured as a function of the laser power, is envisaged for purposes of determining the focal position. Thus, the determination of the focal position is also based in the method presented here on the determination of the diameter of the intensity distribution on the detector.

In the most recently cited publications, the focal position is typically determined by determining the dimensions or the diameter of the beam spot on the detector. Although a focal position can in principle be determined in this manner if the beam parameters are known, such methods are not favourable for a number of reasons: on the one hand, the detected beam diameter also alters with alterations in the divergence and/or diameter of the processing laser beam; on the other hand, especially in the region of the beam waist, an alteration of the diameter with an alteration of the focal position is minimal. Both lead to a considerable uncertainty in the determination of the axial focal position. Finally, based on a measurement in the optimal focal position, it cannot be detected in which direction the beam focus is shifted, since the diameter increases in both directions.

### BRIEF DESCRIPTION OF THE INVENTION

It is therefore the object of the present invention advantageously to develop the principle of optical triangulation, and, in particular, to make it usable for measuring the focal position of laser beams that are guided in laser processing optics, without having to resort to the radiation emitted or reflected by a workpiece, and thus to enable a particularly precise determination of the focal position. It is also an object of the present invention to provide particularly robust, accurate, versatile and compact devices and methods for purposes of determining the focal position and, if applicable, also for purposes of determining further beam parameters.

The task is solved by means of a beam analysis device with the features of Claim 1.

The beam analysis device in accordance with the invention serves to determine an axial position of a beam focus, wherein the beam focus is a focus of an energy beam of electromagnetic radiation, or a focus of a sample beam decoupled from the energy beam, and comprises a beam-shaping device, a detector, and an evaluation device.

The beam-shaping device is set up to modulate an intensity distribution of the energy beam, or the sample beam decoupled from the energy beam, in a modulation plane with a two-dimensional transmission function, so as to form a modulated sample beam that has a modulated intensity distribution, wherein the transmission function has at least one passage region with a substantially constant first intensity transmission factor, and at least one blocking region with a substantially constant second intensity transmission factor, wherein the second intensity transmission factor is at most 50% of the first intensity transmission factor.

The transmission function has at least two contrast steps along a first lateral direction in the form of transitions between the at least one blocking region to the at least one passage region, wherein the contrast steps have a distance k between one another along the first lateral direction.

The term “lateral” can refer to directions in planes that are (at least substantially) at right angles to a respective local optical axis.

The beam-shaping device is further set up to form an intensity distribution on the detector with at least two contrast features along the first lateral direction, and to guide the modulated sample beam along a propagation path onto the detector, wherein the contrast features in the intensity distribution on the detector are formed from the at least two contrast steps in the modulated intensity distribution, by beam propagation of the modulated sample beam to the detector.

The detector comprises a light radiation-sensitive sensor, resolving spatially in two dimensions, which is set up to convert the intensity distribution impinging onto the detector into electrical signals. The detector (in particular its sensor) is arranged along the propagation path at a distance s behind the modulation plane.

The evaluation device is set up to process the electrical signals of the detector, which represent the intensity distribution on the detector.

The evaluation device is furthermore set up to determine a distance a along the first lateral direction between the two contrast features on the detector, and to determine the axial position of the beam focus based on the distance a, and/or to determine an alteration of the axial position of the beam focus based on an alteration of the distance a.

The beam analysis device is a particularly robust, accurate, versatile, and compact device for determining the focal position.

The term “sample beam” can also be understood to mean the term “energy beam”, in particular if the sample beam is not formed by decoupling from the energy beam.

The beam analysis device in accordance with the invention can optionally be further developed by means of one or more of the features listed below.

The evaluation device can be connected to the detector for purposes of receiving the electrical signals from the detector. The evaluation device can, for example, be connected to the detector via at least one data line. Alternatively or additionally, the evaluation device can be wirelessly connected to the detector for purposes of receiving the electrical signals from the detector. In accordance with another aspect, the evaluation device and the detector can be designed in a common unit.

In a preferred form of embodiment, at each of the at least two contrast steps, a section of the passage region extends along the first lateral direction over a width b, and a section of the blocking region extends along the first lateral direction over a width p, respectively.

Particularly preferably, the width b of the sections of the passage region is at least 1.5 times the width p of the sections of the blocking region. This enables a highly accurate measurement.

In a further development, the sections of the passage region and the sections of the blocking region at the contrast steps extend in a second lateral direction over at least a width h. The second lateral direction is at right angles to the first lateral direction.

Extremely preferably, the width h is at least 2 times the width p.

In a preferred form of embodiment, the contrast steps are designed as lines, whose tangents at intersections with the first lateral direction are oriented at right angles to the first lateral direction.

The contrast steps are preferably designed as straight lines oriented at right angles to the first lateral direction.

In accordance with a further aspect, the beam analysis device is preferably set up to alter the first lateral direction and the local optical axis between the modulation plane and the detector, by means of beam folding and/or beam redirection. Furthermore, the second lateral direction can be correspondingly altered by means of beam folding and/or beam redirection. With the aid of beam folding and/or beam redirection, the beam analysis device can, for example, be made more compact, without impairing the measurement accuracy.

The beam analysis device preferably comprises a decoupling device, wherein the decoupling device comprises a beam decoupler for purposes of decoupling the sample beam from the energy beam. In this manner, the beam analysis device can be easily used with existing processing optics. In addition, the decoupling device can enable a measurement by the beam analysis device during normal operation of the processing optics.

Particularly preferably, the beam decoupler is a beam splitter device that is set up to decouple a radiation component in the range from 0.01% to 5% of the energy beam as a sample beam by reflection and/or transmission. In typical applications, this radiation component is sufficient for an accurate measurement on the one hand, while on the other hand, the energy beam is only weakened insignificantly by the decoupling.

The beam-shaping device can comprise an imaging device with at least one optical lens for purposes of guiding the modulated sample beam onto the detector. This enables, for example, the use of a more compact detector. Alternatively or additionally, the measurement accuracy can be improved by this feature.

The modulation plane can be arranged at the image-side focal point (also referred to as second focal point) of the imaging device. This makes evaluation particularly easy.

The evaluation device is preferably set up to determine the axial position of the beam focus, based on the distance a between the contrast features, by means of a calculation rule that is linear in at least some sections. Alternatively or additionally, the evaluation device is preferably set up to determine the alteration of the axial position of the beam focus based on the alteration of the distance a between the contrast features, by means of a calculation rule that is linear in at least some sections. This enables a simple, accurate, and fast evaluation with little calculation effort.

In a further development, the evaluation device is set up to determine the axial position of the beam focus, based on the distance a between the contrast features, by means of a linear calculation rule. Alternatively or additionally, the evaluation device can be set up to determine the alteration of the axial position of the beam focus based on the alteration of the distance a between the contrast features of a linear calculation rule. This enables a particularly simple, accurate, and fast evaluation with particularly little calculation effort.

In an advantageous form of embodiment, the beam analysis device comprises a beam-folding device, which includes a beam splitter and at least one mirror, and which is arranged in the beam path in front of the detector, wherein the at least one mirror is arranged to reflect a radiation component leaving the beam splitter back into the beam splitter, thereby forming a first folded beam path, and wherein the modulation plane is arranged in the beam path in front of the beam-folding device, or in the first folded beam path. Beam folding allows for a more compact design of the beam analysis device without any impairment of measurement accuracy.

In a further development of the beam analysis device, the beam-folding device can additionally include at least one second mirror, wherein the second mirror is arranged to reflect a further radiation component leaving the beam splitter back into the beam splitter, whereby the beam-folding device in this manner forms a second folded beam path. The second folded beam path can, for example, enable the measurement of additional parameters.

In a preferred form of embodiment, the modulation plane of the beam-shaping device is arranged in the first folded beam path, wherein no modulation is arranged in the second folded beam path, in order to guide in this manner a radiation component of the sample beam or the energy beam as an unmodulated beam onto the detector. The evaluation device can be set up to determine a beam diameter and/or a beam profile from an intensity distribution of a beam spot of the unmodulated beam on the detector. This enables the energy beam, or the sample beam, to be characterised more precisely.

In a further development, the mirror is arranged such that it can be axially shifted in the second folded beam path, and the position of the said mirror can be adjusted by means of a positioning device. The axial displacement of the second mirror can be used, for example, to determine the beam caustic (that is to say, the beam envelope) of the energy beam or the sample beam. The evaluation device can be set up correspondingly to determine the beam caustic. In particular, the evaluation device can be set up to control the axial displacement of the said mirror. The evaluation device can be connected to the second mirror, in particular to the positioning device.

The evaluation device is preferably set up to determine a lateral position of the entire intensity distribution on the detector, and for purposes of:
calculating a lateral position of the sample beam from the lateral position of the entire intensity distribution, and/or
calculating an alteration of the lateral position of the beam focus of the sample beam from an alteration of the lateral position of the entire intensity distribution.

In a preferred form of embodiment, the beam analysis device comprises a beam splitter for purposes of splitting the sample beam, a further imaging device with at least one optical lens, and a second detector. Here the beam splitter is arranged in the beam path in front of the plane of the modulation plane, and the beam splitter is arranged between the optical lens of the (aforementioned) imaging device and the modulation plane. At the same time the further imaging device is arranged between the beam splitter and the second detector, and is set up to image an enlarged beam spot, or an enlarged image of the beam focus, onto the second detector. This enables a more precise characterisation of the energy beam or the sample beam.

The evaluation device can be set up to process the electrical signals generated by the second detector, and the evaluation device can be set up to determine a beam diameter, and/or a focal diameter, from an intensity distribution on the second detector.

The evaluation device can be connected to the second detector for purposes of receiving the electrical signals from the detector. The evaluation device can, for example, be connected to the second detector via at least one data line. Alternatively or additionally, the evaluation device can be wirelessly connected to the second detector for purposes of receiving the electrical signals from the detector. In accordance with another aspect, the evaluation device and the second detector can be designed in a common unit.

In accordance with a further aspect, the beam analysis device comprises a beam splitter for splitting the sample beam, a further imaging device with at least one optical lens, and a second detector. Here the beam splitter is arranged in front of the modulation plane in the beam path, and the beam splitter is arranged between the optical lens of the imaging device (mentioned at the beginning, that is to say, firstly) and the modulation plane. The further imaging device is arranged between the beam splitter and the second detector. The imaging device and the further imaging device together form a combined lens system, which has an image-side focal plane (also referred to as second focal plane). The second detector can be arranged in the image-side focal plane of the combined lens system.

The evaluation device can be set up to process the electrical signals generated by the second detector, and the evaluation device can be set up to determine a divergence angle from an intensity distribution on the second detector.

The evaluation device can be connected to the second detector for purposes of receiving the electrical signals of the detector. The provisions for the aforementioned variant of the second detector apply mutatis mutandis.

The above object is furthermore achieved by a system comprising a beam analysis device in accordance with any of the disclosed forms of embodiment and processing optics for purposes of guiding and focussing the energy beam. The beam analysis device can be used to inspect the energy beam.

The advantages mentioned for the respective modification of the beam analysis device apply correspondingly for the system.

The processing optics can comprise a decoupling device for decoupling the sample beam from the energy beam, and the beam analysis device can be connected to the processing optics for purposes of receiving the decoupled sample beam. The beam analysis device can thus be used in a particularly simple manner for the inspection of the energy beam.

The above task is further solved by a method for determining an axial position of a beam focus with the features of Claim 25.

The method serves to determine an axial position of a beam focus, wherein the beam focus is a focus of an energy beam of electromagnetic radiation, or a focus of a sample beam decoupled from the energy beam. The method comprises at least the following steps:
modulation of an intensity distribution of the energy beam, or of the sample beam decoupled from the energy beam, in a modulation plane with a two-dimensional transmission function for purposes of forming a modulated sample beam, which has a modulated intensity distribution (in a lateral plane), wherein the transmission function has at least one passage region with a substantially constant first intensity transmission factor, and has at least one blocking region with a substantially constant second intensity transmission factor, wherein the second intensity transmission factor is at most 50% of the first intensity transmission factor, wherein the transmission function along a first lateral direction has at least two contrast steps in the form of transitions from the at least one blocking region to the at least one passage region, wherein the contrast steps along the first lateral direction are spaced apart by a distance k, the term “lateral” referring to directions in planes at right angles to the respective local optical axis,
guidance of the modulated sample beam onto a detector, which is arranged along a propagation path for the modulated sample beam at a distance s behind the modulation plane, for purposes of forming an intensity distribution on the detector with at least two contrast features along the first lateral direction, wherein the contrast features in the intensity distribution on the detector are formed from the at least two contrast steps in the modulated intensity distribution by beam propagation of the modulated sample beam to the detector,
conversion of the intensity distribution impinging onto the detector into electrical signals by means of a light radiation-sensitive sensor of the detector, resolving spatially in two dimensions,
processing of the electrical signals of the detector, which represent the intensity distribution on the detector,
determination of a distance a along the first lateral direction between the contrast features,
determination of the axial position of the beam focus based on the distance a, or determination of an alteration of the axial position of the beam focus based on an alteration of the distance a.

The method in accordance with the invention allows a particularly robust, accurate, and versatile determination of the focal position.

The beam-shaping device can, in particular, be designed in accordance with any of the described forms of embodiment. The advantages described here apply correspondingly to the beam analysis method.

The evaluation device can, in particular, be designed in accordance with any of the described forms of embodiment. The advantages described here apply correspondingly to the beam analysis method.

The beam analysis method in accordance with the invention can be further developed by means of one of, or by a plurality of, the optional steps listed below.

In a further step, the sample beam can be decoupled from the energy beam, for example by means of a beam decoupler in a decoupling device.

As a sample beam, a radiation component in the range from 0.01% to 5% of the energy beam can be decoupled by reflection and/or transmission, for example by means of the beam decoupler.

The guidance of the modulated sample beam onto the detector can take place by means of an imaging device with at least one optical lens. The imaging device can be arranged in the beam-shaping device.

An image-side focal point of the imaging device can lie in the modulation plane. Modulation of the intensity distribution can take place at the image-side focal point of the imaging device.

Preferably, the determination takes place of:
the axial position of the beam focus based on the distance a between the contrast features, or
the alteration of the axial position of the beam focus based on the alteration of the distance a between the contrast features

by means of a calculation rule that is linear in at least some sections.

In a further development, the determination takes place of:
the axial position of the beam focus based on the distance a between the contrast features, or
the alteration of the axial position of the beam focus based on the alteration of the distance a between the contrast features

by means of a linear calculation rule.

In accordance with another aspect, a first folded beam path is preferably formed by means of a beam-folding device, which includes a beam splitter (and at least one mirror), and which is arranged in the beam path in front of the detector, by reflection of a radiation component leaving the beam splitter back into the beam splitter at the at least one mirror. Here the modulation of the intensity distribution can take place in the beam path in front of the beam-folding device or in the first folded beam path.

In yet another step, a second folded beam path can be formed by means of the beam-folding device, which additionally contains at least one second mirror, by reflecting a further beam component leaving the beam splitter back into the beam splitter at the second mirror.

In a further development, the modulation of the intensity distribution takes place in the first folded beam path, wherein no modulation of an intensity distribution takes place in the second folded beam path, and a radiation component is guided onto the detector as an unmodulated beam. Here a beam diameter and/or a beam profile can be determined from an intensity distribution of a beam spot of the unmodulated beam on the detector, for example by means of the evaluation device.

Particularly preferably, the axial position of the mirror in the second beam path is varied by means of a positioning device, and an intensity distribution of the beam spot of the unmodulated beam is registered on the detector for each of at least three different positions of the mirror. Optionally, at least one beam parameter of the unmodulated beam is determined from the registered intensity distributions, for example by means of the evaluation device.

In a further development of the method, the method comprises the following steps:
splitting the sample beam by means of a beam splitter, which is arranged in the beam path behind the optical lens of the (first described) imaging device and in front of the modulation plane.
imaging of a split-off sample beam onto a second detector by means of a further imaging device comprising at least one optical lens, which is arranged between the beam splitter and the second detector for purposes of forming an enlarged beam spot or an enlarged image of the beam focus on the second detector.
determination of a beam diameter or a focal diameter from an intensity distribution on the second detector.

In accordance with another aspect, the method preferably comprises the following steps:
splitting the sample beam by means of a beam splitter arranged in the beam path behind the optical lens of the (first described) imaging device and in front of the modulation plane.
guidance of a split-off sample beam onto a second detector by means of a further imaging device with at least one optical lens, which is arranged between the beam splitter and the second detector, for purposes of forming a far-field beam distribution on the second detector. Here the imaging device and the further imaging device together form a combined lens system which has an image-side focal plane. The second detector is here arranged in the image-side focal plane of the combined lens system.
determination of a far-field beam diameter or a divergence angle from an intensity distribution on the second detector.

In an advantageous further development of the method, the energy beam is focused by processing optics.

Particularly preferably, the determined axial position of the beam focus, or the determined alteration of the axial position of the beam focus, is used to control a laser processing operation.

### SHORT DESCRIPTION OF THE FIGURES

The invention is illustrated in more detail with the aid of the following figures, without being limited to the forms of embodiment and examples shown. Rather, forms of embodiment are also envisaged in which elements and aspects can be combined, as illustrated in various figures. Here:

FIG. 1: shows a schematic representation of a form of embodiment of the beam analysis device in accordance with the invention.

FIG. 2: shows a schematic representation of a form of embodiment of the beam analysis device that is similar to FIG. 1, with an additional decoupling device.

FIG. 3: shows a schematic representation of a modulation device for the beam analysis device, a schematic representation of a transmission function of the modulation device, as well as a schematic representation of exemplary intensity profiles in front of and behind the modulation device.

FIG. 4: shows a schematic, exemplary representation of an intensity distribution on the detector with the contrast features, wherein the alteration of the intensity distribution with an alteration of the focal position is also illustrated.

FIG. 5: shows an exemplary representation of the profile of a simulated intensity distribution on the detector with the contrast features, wherein the alteration of the profile of the intensity distribution with an alteration of the focal position is also illustrated.

FIG. 6: shows a schematic representation of a variant of embodiment of the beam analysis device, in which the modulation device is arranged in the focal plane of the imaging device.

FIG. 7: shows a schematic representation of a further form of embodiment of the beam analysis device with a beam-folding device for purposes of forming two different beam paths onto the detector, in which a modulation device is only arranged in one beam path.

FIG. 8: shows a schematic representation of a further form of embodiment of the beam analysis device with two beam paths onto the detector, in which a modulation device is only arranged in one beam path, and in which the beam path length for the unmodulated beam can be adjusted.

FIG. 9: shows a schematic representation of a further form of embodiment of the beam analysis device with two beam paths that is similar to FIG. 7, and with an additional beam splitting and imaging of a far-field beam distribution of the sample beam onto a second detector.

### DETAILED DESCRIPTION OF THE FIGURES

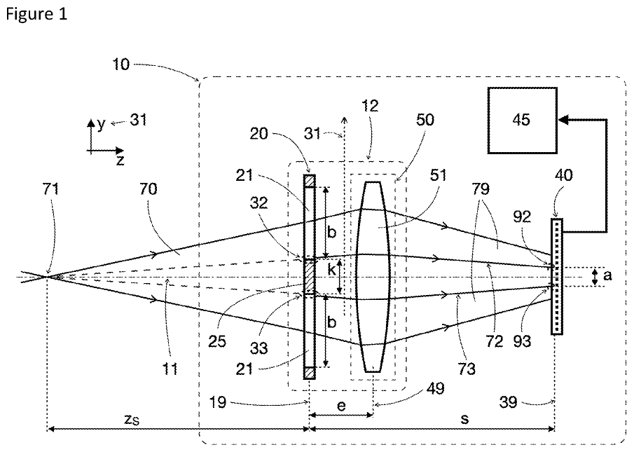

FIG. 1 shows a beam analysis device 10 in accordance with the invention, which includes a beam-shaping device 12, a detector 40, and an evaluation device 45. The beam-shaping device 12, the detector 40, and the evaluation device 45, are preferably arranged together in a housing. The beam analysis device 10 receives a sample beam 70 propagating along an optical axis 11 with a beam focus 71. The beam-shaping device 12 comprises a modulation device 20 and an imaging device 50, which in this example of embodiment are designed as independent devices. The modulation device 20 serves to modulate the intensity distribution of the sample beam 70 in a modulation plane 19. For this purpose, the modulation device 20 has at least two regional sections of a passage region 21 and at least one regional section of a blocking region 25. In the passage region 21, the radiation propagates further to the detector 40; in the blocking region 25, the propagation of the radiation to the detector is impeded. The modulation device 20 thus provides a transmission function, by means of which the intensity distribution of the sample beam 70 is modulated and a modulated sample beam 79 is thus formed. Along a first lateral direction 31 the transmission function has two contrast steps 32, 33 in the form of transitions between the blocking region and the passage region 21. The contrast steps 32, 33 are a distance k apart from each other along the first lateral direction 31, wherein the term “lateral” refers to directions in planes at right angles to the optical axis 11. By means of the beam-shaping device 12, the sample beam 70, or the modulated sample beam 79, is guided onto the detector 40. In doing so, the intensity distribution of the modulated sample beam is reduced in lateral extent by utilisation of the imaging properties of the imaging device 50. The detector 40 is not arranged at the location of an image of the beam focus 71. In a sensor plane 39 the detector 40 has a light radiation-sensitive sensor, resolving spatially in two dimensions, which converts the intensity distribution on the detector into electrical signals that are received and processed by the evaluation device 45. In this form of embodiment, the evaluation device 45 is electrically connected to the detector 40 for this purpose. The imaging device 50 contains at least one optical lens 51. By the guidance of the modulated sample beam 79 onto the detector 40, at least one contrast feature 92, 93 is formed in the intensity distribution on the detector for each contrast step 32, 33. The two contrast features 92, 93 are a distance a apart from each other on the detector 40 in the first lateral direction 31. The distance a depends on, amongst other items, the distance k between the contrast steps 32, 33, the distance s between the modulation plane 19 and the sensor plane 39, the distance zₛ between the axial position of the beam focus 71 and the modulation plane 19, and the distance e between the position of the lens 51, more precisely the position of the principal plane of the imaging device 50, and the modulation plane 19. Thus, the axial position of the beam focus 71 can be determined from the distance a. The distance a would be zero if the image position of the beam focus 71 falls on the detector 40, or on the sensor plane 39; moreover, no contrast features would be formed in an intensity distribution in the image of the beam focus 71. The detector 40, or the sensor plane 39, is therefore arranged at an axial distance from the image position of the beam focus 71.

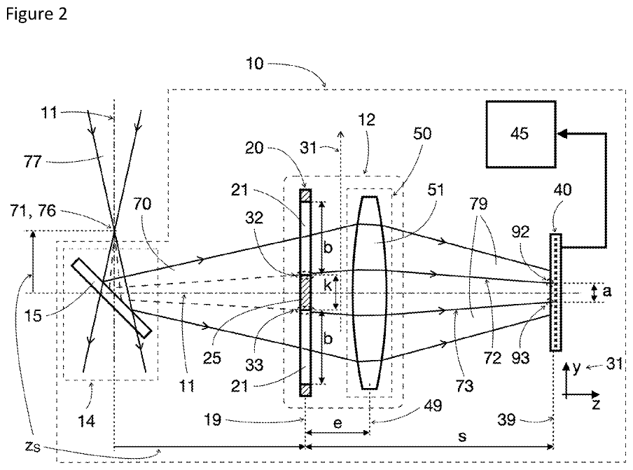

FIG. 2 represents a beam analysis device 10 that is similar to the form of embodiment shown in FIG. 1. The variant of embodiment of the beam analysis device 10 shown in FIG. 2 differs from the form of embodiment in accordance with FIG. 1 by having an additional decoupling device 14. The decoupling device 14 comprises a beam decoupler 15. By means of the beam decoupler 15, the sample beam 70 is decoupled from an energy beam 77 of electromagnetic radiation, for example a laser beam. In this example, the beam decoupler 15 is a plane plate, which is arranged as a beam splitter, and at one interface of which a fraction of the intensity of the energy beam 77 is reflected as the sample beam 70. The plane plate can be coated, for example with a reflection-reducing layer, for purposes of adjusting the degree of reflection. A low residual reflection of usual anti-reflective coatings in the range from about 0.05% to about 1% can be sufficient for providing the sample beam 70. The decoupling device 14 thus simultaneously reduces and/or limits a radiation intensity of the sample beam 70. Beams 72, 73 are formed at the contrast steps 32, 33; the points at which they impinge on the detector 40 represent the positions of the contrast features 92, 93. All other features of the form of embodiment in FIG. 2 correspond to the features shown in FIG. 1, the same reference symbols correspond to the same features as in FIG. 1; in this respect, reference is made to the description of FIG. 1 for the other features.

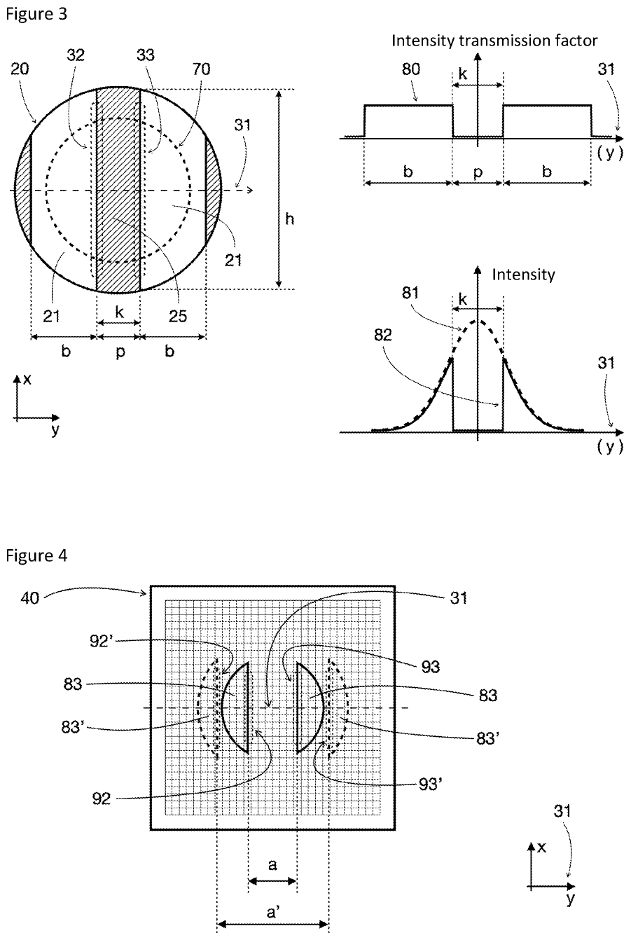

FIG. 3 shows an example of a modulation device 20, such as can be used in a beam analysis device 10 in accordance with FIG. 1 or 2. The modulation device 20 has two regional sections of the passage region 21, with a width b on either side of a centrally arranged regional section of the blocking region 25 with a width p. In each case, a transition between a regional section of the passage region 21 and a regional section of the blocking region 25 forms one of the contrast steps 32, 33. The contrast steps 32, 33 are the distance k apart from each other in the first lateral direction. No radiation is transmitted in the blocking region 25; the blocking region 25 can consist of an absorbing and/or a reflecting material. The exemplary transmission function 80 formed in this manner is shown schematically in the upper right-hand part of FIG. 3. The sample beam 70 impinges on the modulation device 20 and has an intensity distribution 81 in front of the modulation device 20, which can, for example, be Gaussian in form. After modulation by the modulation device 20, the sample beam has the intensity distribution 82 on which the transmission function 80 is impressed, so that the contrast steps 32, 33 included in the transmission function 80 are now included in the intensity distribution 82. The intensity distributions in front of (81) and behind (83) the modulation device are shown schematically in the lower right-hand part of FIG. 3 for a Gaussian-form sample beam 70.

FIG. 4 is a schematic exemplary representation of an intensity distribution 83 on the detector 40 in a beam analysis device 10 in accordance with FIG. 1 or 2, with a modulation device 20 as shown in FIG. 3. The intensity distribution on the detector 40 is composed of two regions of higher intensity, which in this example are in the form of circular sections. The contrast features 92 and 93, caused by contrast steps 32, 33, are formed on the inner edges of the circular sections. The intensity distribution 83 on the detector represents a (reduced) shadow cast by the modulation device 20, which is illuminated by the sample beam 70. The contrast features 92, 93 are a distance a apart from each other in the first lateral direction 31. The distance a alters in the event of an alteration of the axial position of the beam focus 71. FIG. 4 additionally illustrates the alteration of the distance a between the contrast features 92, 93 on the detector 40 in the event of an alteration of the axial position of the beam focus 71. The apostrophised reference symbols in the figure indicate the details altered by the axial displacement of the beam focus. An alteration of the beam focal position by an amount Δz=zₛ−zₛ′ causes an alteration of the spacing of the contrast features 92, 93 by an amount Δa=a′−a.

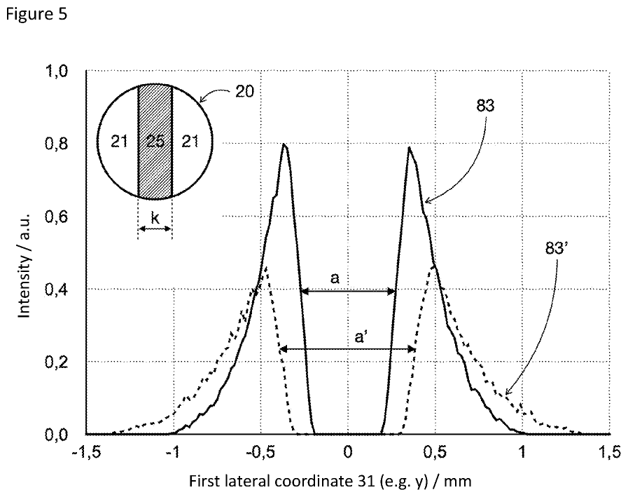

FIG. 5 shows an example of the intensity distribution 83 on the detector 40 for a beam analysis device 10 in accordance with FIG. 1 or FIG. 2, with a modulation device 20 in accordance with FIG. 3. The two curves show the result of a simulation of the beam analysis device 10 using ray tracing software. Here an incoherent beam with a focal diameter of 0.1 mm and a divergence of 67 mrad was assumed. The width p of the central section of the blocking region, which in this example is identical to the distance k between the contrast steps, is 6 mm. The distance zₛ from the beam focus to the modulation device is 100 mm, the distance s from the modulation device to the detector is 180 mm, and the focal length of the lens is 67 mm. The solid curve represents the intensity distribution with the beam focus 71 in its original position, while the dashed curve shows the intensity distribution in the event of an axial shift of the focal position by 2 mm. Due to the propagation path to the detector 40, the contrast steps 32, 33 are indeed “blurred”, but the positions of the contrast features 92, 93 in the intensity distribution 83 can still be determined clearly and with high accuracy.

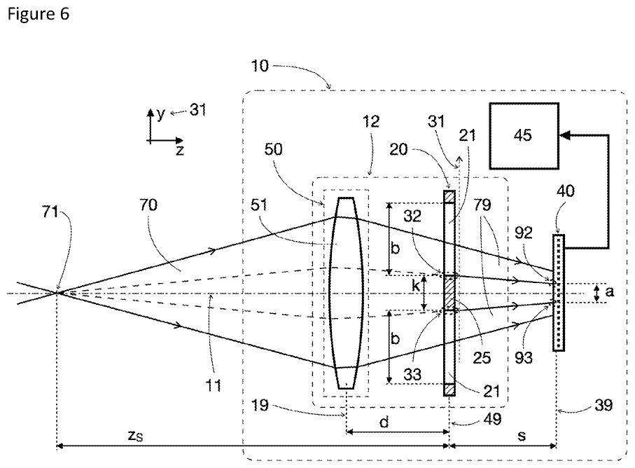

FIG. 6 represents a variant of the beam analysis device in which the imaging device 50 is arranged in front of the modulation device 20 in the beam direction. The distance d in this case is the distance between the position of the lens 51, more precisely, the position of the principal plane of the imaging device 50, and the modulation plane 19. A particularly advantageous form of embodiment is provided if the distance d is equal to the focal length f of the imaging device 50, that is to say, if the modulation plane 19 is arranged at the image-side focal point of the imaging device 50. Such forms of embodiment will be explained in more detail in the section containing the detailed description of the invention. All other details shown correspond to the details of FIG. 1.

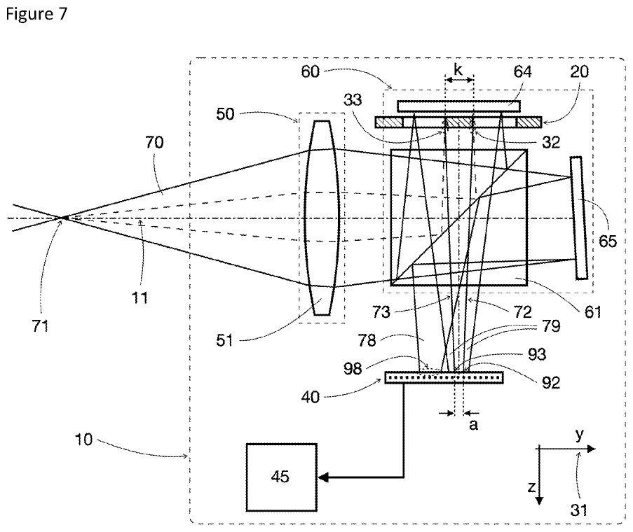

FIG. 7 shows a form of embodiment of the beam analysis device 10, which comprises a beam-shaping device 12, a beam-folding device 60, a detector 40, and an evaluation device 45. The beam-shaping device 12, the beam-folding device 60, the detector 40, and the evaluation device 45, are preferably arranged together in one housing. The beam-shaping device 12 comprises the imaging device 50 with the at least one optical lens 51 and the modulation device 20. The beam-folding device 60 comprises the beam splitter 61 and the mirrors 64, 65. The beam-folding device 60 is arranged behind the lens 51 of the imaging device 50 in the beam direction. The beam splitter 61 splits the sample beam 70 into two radiation components. The first of the two radiation components passes through the modulation device 20 and impinges on the mirror 64. By means of the modulation device 20, the intensity distribution of the sample beam 70 is modulated and the contrast steps 32, 33 are impressed. The contrast steps 32, 33 are a distance k apart from each other in the first lateral direction 31. Subsequently, the modulated sample beam 79 formed in this manner is reflected back into the beam splitter 61 by means of the mirror 64 of the beam-folding device 60, as a result of which the first folded beam path is formed. After passing through the beam splitter 61, the second of the two radiation components impinges on the mirror 65, and is reflected by the latter back into the beam splitter 61, as a result of which the second folded beam path is formed. In the second folded beam path, no modulation of the intensity distribution of the sample beam 70 takes place, so that an unmodulated beam 78 is formed in the second beam path. In the beam splitter 61, the two radiation components from the two folded beam paths are superimposed and directed along a common propagation path with a local optical axis 11 onto the detector 40. The intensity distribution on the detector 40 is thus composed of the intensity distribution 83 with the contrast features 92, 93, and a laterally spaced beam spot 98, which is formed by the unmodulated beam 78. The lateral spacing of the beam spot 98 from the intensity distribution 83 can be achieved, for example, by a slight tilting of one of the two mirrors 64, 65. The two contrast features 92, 93 in the intensity distribution 83 are formed in the manner as previously explained by the propagation of the modulated sample beam 79, on which the contrast steps 32, 33 are impressed. The contrast features 92, 93 are a distance a apart from each other on the detector 40 in the first lateral direction 31. The distance a alters in the event of an alteration of the axial position of the beam focus 71. Based on the distance a, or an alteration of the distance a, the evaluation device 45 determines the axial focal position, or the alteration of the axial focal position, of the beam focus 71. A third beam spot 98 is formed on the detector 40 by the imaging of the unmodulated beam 78 propagating via the second folded beam path. The beam spot 98 of the unmodulated beam thus represents the original intensity distribution of the sample beam 70, or the energy beam 77, from which the sample beam 70 can be decoupled. In particular, the beam spot 98 can also be an image of the beam focus 71. With the aid of the imaging scale of the imaging by the imaging device 50, the intensity distribution and/or the diameter of the beam focus 71 can therefore also be determined by the evaluation device 45. For purposes of imaging an image of the beam focus 71 onto the detector 40, the second folded beam path via the mirror 65 can have a different, in particular a longer, beam path length.

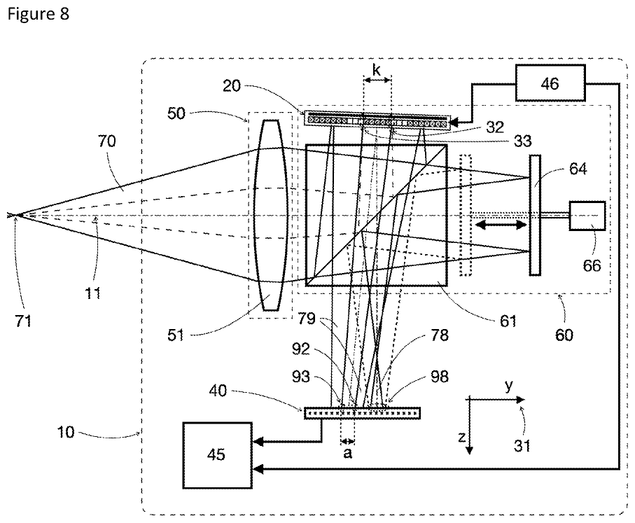

The variant of embodiment shown in FIG. 8 differs from the form of embodiment in FIG. 7 in terms of the following features: The second folded beam path has a variably adjustable beam path length. For this purpose, the mirror 64 is arranged such that it can be axially shifted, for example by means of a linear guide, and is coupled to a positioning device 66. By means of the positioning device 66, the mirror 64 can be shifted to different axial positions (64, 64′). The positioning device 66 can include, for example, a plunger coil drive, whereby very fast adjustments, for example in the range of milliseconds, can be implemented. The evaluation device 45 can be set up to control the positioning device 66. The evaluation device 45 can also be set up to exchange data with the positioning device 66, for example to exchange information concerning the mirror position or alteration of the adjustment path. Thus, a number of mirror positions, preferably at least 3, particularly preferably at least 10, can be set one after another and the respective intensity distribution of the beam spot 98 on the detector 40 can be registered. From these data, various beam parameters of the sample beam 70 can be determined, for example the focal diameter, the beam divergence, and/or the beam parameter product. The beam analysis device 10 shown here is thus able, on the one hand, to determine the axial beam focal position in quasi-real time, and, on the other hand, to measure the beam caustic (that ist to say, the beam envelope) of the sample beam 70 or the energy beam 77 almost in real time, or at least in a very short period of time. This also makes it possible to measure the beam in accordance with the ISO 11146 standard in a very short period of time, for example in less than one second. FIG. 8 shows yet another aspect. The modulation device 20 in the first folded beam path is here designed in an exemplary manner as a switchable and spatially controllable reflector. For this purpose, the modulation device 20 can contain, for example, an LCD (liquid crystal display) panel with a mirror arranged behind it, or an LCOS (liquid crystal on silicon) element. The switchable modulation device 20 is controlled by a control device 46, which can exchange data with the evaluation device 45.

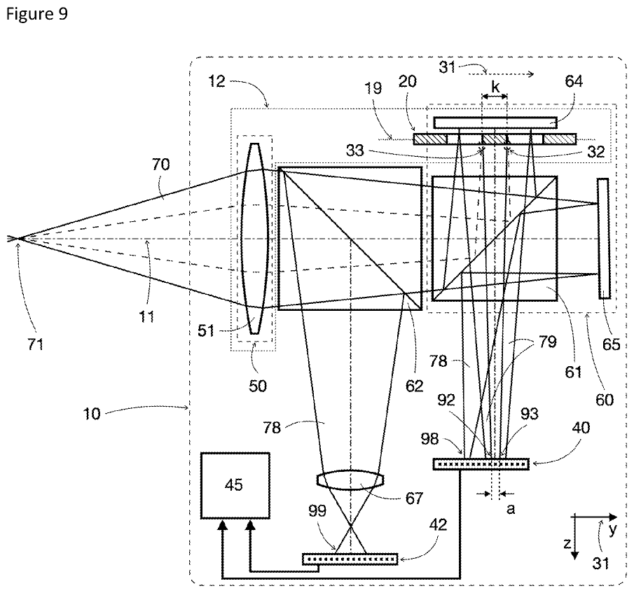

FIG. 9 shows a form of embodiment of a beam analysis device 10, which additionally comprises a far-field analysis device. The said far-field analyser can be combined with any of the beam analysis devices 10 previously described. The far-field analysis device comprises a second beam splitter 62, a further imaging device 67, and a second detector 42. The second beam splitter 62 is arranged in the beam direction behind the at least one lens 51 of the imaging device 50, and in front of the modulation device 20, and also in front of the beam-folding device 60. By means of the second beam splitter 62, a radiation component is decoupled from the sample beam 70 to form a (possibly further) unmodulated beam 78, which is guided onto the second detector 42 to form a beam intensity distribution 99 on the second detector 42. Between the second beam splitter 62 and the second detector 42 is arranged the further imaging device 67, which contains at least one optical lens, or can be a multi-lens objective. Together with the imaging device and the lens 51 contained therein, the further imaging device 67 forms a combined lens system. The said combined lens system has a combined focal length and an image-side focal plane of the combined lens system. The second detector 42 is arranged exactly in the image-side focal plane of the combined lens system. The combined lens system thus forms a so-called Fourier lens for the second detector 42, because the intensity distribution 99 of the unmodulated beam 78 formed on the second detector 42 is a Fourier transform of the intensity distribution of the sample beam 70. The intensity distribution 99 on the second detector 42 is therefore the so-called far-field intensity distribution, which is independent of the axial position of the beam focus 71. From this intensity distribution 99, therefore, a divergence angle of the sample beam 70 can, in particular, be determined. In other details, the form of embodiment corresponds to the device shown in FIG. 7 and explained in the related text.

### DETAILED DESCRIPTION OF THE INVENTION

The invention envisages a beam analysis device 10 for determining an axial position of a beam focus 71. Here the beam focus 71 is a focus 76 of an energy beam 77 of electromagnetic radiation, or a focus of a sample beam 70 decoupled from the energy beam 77. The beam analysis device 10 comprises a beam-shaping device 12, a detector and an evaluation device 45.

The beam-shaping device 12 is set up to modulate an intensity distribution 81 of the energy beam 77, or of the sample beam 70 decoupled from the energy beam 77, in a modulation plane 19 with a two-dimensional transmission function so as to form a modulated sample beam 79, which has a modulated intensity distribution 82. Here the transmission function has at least one passage region 21 with a substantially constant first intensity transmission factor, and at least one blocking region 25 with a substantially constant second intensity transmission factor. The second intensity transmission factor is at most 50% of the first intensity transmission factor. Along a first lateral direction 31 the transmission function has at least two contrast steps 32, 33 in the form of transitions between the at least one blocking region 25 and the at least one passage region 21. The contrast steps 32, 33 are a distance k apart from each other along the first lateral direction 31, wherein the term “lateral” refers to directions in planes at right angles to the respective local optical axis 11.

The first lateral direction 31 lies in a plane that stands at right angles to the local optical axis 11. Since the local optical axis 11 in a beam path is always identified with a z-axis of a local coordinate system, the first lateral direction 31 therefore lies in an x-y plane.

The beam-shaping device 12 is further set up to guide the modulated sample beam 79 along a propagation path onto the detector 40 for purposes of forming an intensity distribution 83 on the detector 40 with at least two contrast features 92, 93 along the first lateral direction 31, wherein the contrast features 92, 93 in the intensity distribution 83 on the detector 40 are formed from the at least two contrast steps 32, 33 in the modulated intensity distribution 82 by beam propagation of the modulated sample beam 79 to the detector 40. The contrast features 92, 93 are a distance a apart from each other in the first lateral direction 31, which distance is influenced in particular by the distance k between the contrast steps of the transmission function.

In other words, the contrast feature 92, which is caused by the first of the at least two contrast steps on the detector 40 and in the intensity distribution 83, and the contrast feature 93, which is caused by the second of the at least two contrast steps on the detector 40 and in the intensity distribution 83, in the intensity distribution 83 have the distance a along the first lateral direction 31.

The transmission function is a function that defines the (location-dependent) magnitude of an intensity transmission factor over a (lateral) two-dimensional region.

The intensity transmission factor is the ratio of a radiation intensity immediately after the modulation to a radiation intensity immediately before the modulation at the same lateral position.

The magnitude of the intensity transmission factor can in principle lie in the range between zero and one.

The modulation of the intensity distribution 81 of the beam-shaping device 12 is implemented, for example, by a modulation device 20 that is set up to form at least one passage region 21 and at least one blocking region 25. The passage region 21 and the blocking region 25 can each be contiguous regions; however, the passage region 21 and/or the blocking region 25 can also be implemented as a plurality of sections that are separated from each other.

The passage region 21 is characterised in that a transmittance for the radiation within the passage region 21, 22 is substantially greater than that within the blocking region 25. The term transmittance is to be understood here with respect to the intended propagation direction of the modulated sample beam 79 formed in this manner. The transmittance is, in particular, defined by the intensity transmission factor. The intensity transmission factor can be determined, for example, by a radiation transmittance, and/or a radiation reflectance.

In particular, a radiation transmittance (or reflectance) in the passage region 21 is at least twice as high as a radiation transmittance (or reflectance) in the blocking region 25. The radiation transmittance (or reflectance) in the blocking region 25 is preferably, at least 10 times smaller than the radiation transmittance (or reflectance) in the passage region 21. Particularly preferably, the radiation transmittance (or reflectance) in the blocking region 25 is at least 100 times smaller than the radiation transmittance (or reflectance) in the passage region 21.

The detector 40 comprises a light radiation-sensitive sensor, resolving spatially in two-dimensions, which is set up to convert the intensity distribution 83 impinging on the detector 40 into electrical signals. The detector 40 can be a CCD camera, or a CMOS camera, or a comparable device. The light radiation-sensitive sensor, resolving spatially in two-dimensions, is typically a pixel-based semiconductor sensor. The detector 40 is arranged along a propagation path for the modulated sample beam 79 at a distance s behind the modulation plane 19.

The evaluation device 45 is set up to process the electrical signals of the detector 40, which represent the intensity distribution 83 on the detector 40. The evaluation device 45 is set up to determine a distance a along the first lateral direction 31 between the contrast features 92, 93 on the detector 40. The position of the respective contrast feature 92, 93 is preferably defined by the centre of the gradient region, and/or by the location of the mean intensity value in a gradient region of the intensity distribution 83 of the respective contrast feature 92, 93 on the detector 40. Here the gradient regions are the regions in the intensity distribution 83 that are formed by the propagation of the contrast steps 32, 33 in the intensity distribution 82 behind the modulation device 20.

The evaluation device 45 is furthermore set up to determine an axial position of the beam focus 71, based on the distance a, and/or to determine an alteration of the axial position of the beam focus 71, based on an alteration of the distance a.

The evaluation device 45 can, for example, be implemented in the form of a software program running on a computer.

In order to achieve a high accuracy when determining the positions of the beam spots 92, 93 on the detector 40, it is favourable if the profile of the transmission function between the passage region 21 and the blocking region 25, that is to say, the transition to the formation of the contrast edges 32, 33, is as steep as possible, for example it alters abruptly. The profile of the corresponding contrast feature 92, 93 in the intensity distribution 83 on the detector is then also as narrow or steep as possible. On the other hand, sharp contrast edges promote the formation of diffraction structures, which is why a continuous progression can also be envisaged in the transition between the passage region 21 and the blocking region 25. The modulation depth of diffraction structures can be reduced if the width of the regional sections of the passage region 21 and of the blocking region 25 are not identical.

In the event of an alteration of the axial position of the beam focus 71, the distance a between the contrast features 92, 93 on the detector 40 alters. That is to say, the distance a has a functional relationship with the z-position of the beam focus 71. This functional relationship is influenced and/or defined by the following geometric quantities:
a is the distance between the contrast features 92 and 93 on the detector 40;
a′ is the distance between the contrast features 92′ and 93′ on the detector 40 in the event of an altered beam focal position;
Δa is the alteration of the distance between the contrast features 32, 33, Δa=a′−a;
k is the distance between the contrast steps 32, 33 in the modulation plane 19 in the first lateral direction 31;
zₛ is the distance between the axial position of the beam focus 71 and the modulation plane 19;
zₛ′ is the distance between the axial position of a shifted beam focus 71′ and the modulation plane 19;
Δz is the alteration of the axial beam focal position, Δz=zₛ−zₛ′;
s is the distance between the modulation plane 19 and the sensor plane 39 of the detector 40;
e is the distance from the modulation plane 19 to the position of the imaging device 50, more precisely, to the principal plane of the imaging device 50, if the modulation device 20 with the modulation plane 19 is arranged in front of the imaging device 50.
d is the distance from the position of the imaging device 50, more precisely, from the principal plane of the imaging device 50, to the modulation plane 19, if the modulation device 20 with the modulation plane 19 is arranged behind the imaging device 50.

In practice, the modulation plane 19 is usually not of significant interest as a reference point for the distance of the beam focal position 71. It is more practical if the reference point can be arbitrarily chosen or calibrated. For this purpose, it is advantageous to specify a functional relationship that directly describes the alteration of focal position. From the application of the intercept theorems and the known imaging equations, the following functional relationship is obtained for the ray analysis device 10:

Δz=Δac₁/(c₂+Δac₃)

The formula symbols c₁, c₂, c₃ are coefficients introduced for a simplified representation of the formula.

For the case in which the modulation device 20 is arranged in front of the imaging device 50 (cf. FIG. 1 or 2), the coefficients c₁, c₂, c₃ are given by:

c₁=zₛ²

c₂=k{s[1−(e/f)]+(e²/f)}

c₃=zₛ

For the case in which the modulation device 20 is arranged behind the imaging device 50 (cf. FIGS. 6 to 9), the coefficients c₁, c₂, c₃ are given by:

c₁=[zₛ(f−d)+d²]²

c₂=f²ks

c₃=(f−d)[zₛ(f−d)+d²]

The coefficients c₁, c₂, c₃ can be determined by setting at least 3 different known axial positions of the beam focus 71, and determining the corresponding alteration Δa of the distance a. The coefficients determined in this manner can be stored as calibration data in the evaluation device 45, with which the focal position alteration Δz can then be calculated by the evaluation device 45 for any distance alterations Δa.

Alternatively or additionally, the coefficients can be calculated directly from the geometric distances of the arrangement using the formulae given above and stored in the evaluation device 45.

Here it should be noted that all axial distances, that is to say, zₛ, d, e, s, are the distances along the optical axis 11. In the case of a beam deflection, the distances zₛ, d, e, s, are therefore composed, if necessary in a piecewise manner, of the respective distances along the local optical axes 11. It should also be noted that when the beams are partially guided through optical material, such as when guided through a beam splitter cube, the corresponding partial distances must be corrected by a factor dependent on the refractive index of the optical material.

In the variant of embodiment of the beam analysis device 10 with the modulation device 20 behind the imaging device 50, that is to say, behind the at least one optical lens 51 in the beam direction, there is a particularly interesting special case in which the distance d from the principal plane of the imaging device 50 to the modulation plane 19 is equal to the focal length f of the imaging device 50. In other words, the modulation plane 19 is arranged at the image-side focal point of the imaging device 50. For such a form of embodiment of the beam analysis device 10, the coefficients of the functional relationship are given by:

c₁=f⁴

c₂=f²ks

c₃=0

This results in a particularly simple functional relationship with the particular feature that the alteration Δa in the distance a between the contrast features 92, 93 is exactly proportional to the alteration Δz in the axial beam focal position:

Δz=Δaf²/(ks)

With this linear relationship, the calibration of the device is simplified and a high accuracy is achieved in the determination of the focal position.

In such an arrangement it is particularly advantageous that the absolute z position of the beam focus (zₛ) is not required for the calculation of an alteration of the focal position Δz.

This feature or arrangement can advantageously be implemented in forms of embodiment where a distance between the imaging device 50 and the modulation device 20 is provided in any case, for example when the modulation device 20 is arranged in the folded beam path. This aspect of the invention can therefore furthermore be advantageously combined in forms of embodiment in which two folded beam paths are implemented and no modulation device is present in one of the folded beam paths, so that the original beam profile of the sample beam 70 can be simultaneously registered and determined (cf. FIGS. 7 and 9). In the further combination with an axially adjustable mirror 64 or 65 in the beam path of the unmodulated beam 78, the recording of an entire beam caustic and thereby the determination of all geometric beam parameters is also possible (cf. FIG. 8).

The first lateral direction 31 can be defined locally. It is in each case (at least substantially) at right angles to the local optical axis 11. In particular, it can be defined as that direction in a plane at right angles to the local optical axis 11, along which in this plane the contrast features 92, 93 are spaced apart only by virtue of the distance k between the contrast steps 32, 33.

The sample beam 70 can be identical to the energy beam 77, in particular, if the sample beam 70 is not formed by decoupling from an energy beam.

In a further embodiment of the invention, the modulation device 20 can be switched for purposes of altering the transmission function.

Particularly preferably, the modulation device 20 can be switched. For example, the beam-shaping device 12 can form an LCD screen device for purposes of forming the contrast edges 32, 33. In this case, a plane of the LCD screen device can define the modulation plane 19.

The regional sections of the passage region 21 and the regional section(s) of the blocking region 25 are preferably invariant for purposes of forming the contrast steps 32, 33 of the beam-shaping device 12. Such contrast steps 32, 33 can be designed, for example, in terms of a fixed screen opening and/or a (spatially limited) reflective surface of a mirror. This enables a simple, robust, reliable, and cost-effective implementation.

In a preferred form of embodiment, the contrast steps 32, 33 of the beam-shaping device 12 are variable. Variable contrast steps 32, 33 can be implemented, for example, in terms of a plurality of pixels of an LCD screen device, and/or a screen opening of a mechanically adjustable size. Variable contrast steps 32, 33 can enable an adaptation to current measurement conditions (for example light intensity, light distribution in the light beam to be measured, wavelength(s), etc.).

A beam direction can be defined locally. The beam direction can, viewed globally, alter, for example by means of beam folding and/or beam redirection. The local beam direction can be defined, for example, by a direction of a local Poynting vector of the sample beam 70.

In the propagation direction of the radiation downstream of the modulation plane 19, a local beam direction of a modulated sample beam 79 can be defined by a direction of a local Poynting vector of the respective modulated sample beam 79. Alternatively, the local (collective) beam direction can be defined by the Poynting vector of a fictitious profile of the sample beam without modulation.

The local optical axis 11 can, for example, be defined by the intended local overall beam direction when in operation.

An advantage of the invention is that the measuring principle of the beam analysis device is based on the determination of positions of uniquely identifiable features, the contrast features, on the detector. The determination of the positions and their distance from each other is largely independent of, for example, the level of a constant signal background, which can be caused by scattered light and/or sensor noise. This makes the measurement principle less error-prone than other methods that are based, for example, on the determination of a beam diameter, that is to say, the second moment of an intensity distribution, and its alteration, because the determination of a second moment is relatively sensitive to alterations in the background level.

A further significant advantage of the invention is that the determination of the axial position of the beam focus is not influenced by variations in the beam quality of the laser radiation or the sample beam.

The determination of alterations in the axial position of the beam focus is possible in quasi-real time, that is to say, the determination requires only a fraction of the typical time constant of focal position alterations caused by the thermal focal shift. The invention is therefore also capable of providing signals for controlling the laser material processing during a laser processing operation.

The invention can be further developed in a wide variety of ways without departing from the scope and the object of the invention. Numerous configurations and possible embodiments are shown in the figures and explained in the figure descriptions, although the invention is not limited to the forms of embodiment shown. Various features or forms of embodiment shown in the figures can also be combined with each other to arrive at further forms of embodiment of the invention.

For the purposes of this disclosure, an energy beam is preferably a beam of electromagnetic radiation having a wavelength in the range from 0.1 μm to 10 μm, particularly preferably in the range from 0.3 μm to 3 μm, and more in particular in the range from 0.3 μm to 1.5 μm.

For the purposes of this disclosure, the laser radiation is preferably electromagnetic radiation in the range from 0.3 μm to 1.5 μm and with a power of at least 1 mW, particularly preferably with a power of at least 100 W.

### LIST OF REFERENCE SYMBOLS

10 Beam analysis device
11 Optical axis, local optical axis
12 Beam-shaping device
14 Decoupling device
15 Beam decoupler
16 Second beam decoupler
19 Modulation plane
20 Modulation device
21 Passage region
25 Blocking region
31 First lateral direction
32, 33 Contrast steps (transitions between passage region and blocking region)
37 Second lateral direction
39 Sensor plane
40 Detector
42 Second detector
43 Absorber device
44 Absorber and/or power measuring device
45 Evaluation device
46 Control device
49 Position of the imaging device, principal plane of the imaging device
50 Imaging device
51 Optical lens
60 Beam-folding device
61 Beam splitter
62 Second beam splitter
63 Further imaging device
64, 65 Mirror
66 Positioning device
67 Further imaging device
68 Deflection mirror
70 Sample beam
71 Beam focus
72, 73 Beams formed at the contrast steps
76 Energy beam focus
77 Energy beam
78 Unmodulated beam
79 Modulated sample beam
80 Transmission function
81 Intensity distribution in front of the modulation device
82 Intensity distribution behind the modulation device
83 Intensity distribution on the detector
92, 93 Contrast features
98 Beam spot of the unmodulated beam
99 Far-field intensity distribution
100 Processing optics
110 Optical fibre end
113 Collimator
116 Focussing optics
120 Protective glass

1. A beam analysis device (10) for determining an axial position of a beam focus (71), wherein
the beam focus (71) is a focus (76) of an energy beam (77) of electromagnetic radiation, or a focus of a sample beam (70) decoupled from the energy beam (77), comprising a beam-shaping device (12), a detector (40), and an evaluation device (45);
wherein the beam-shaping device (12)
is set up to modulate an intensity distribution (81) of the energy beam (77), or of the sample beam (70) decoupled from the energy beam (77), in a modulation plane (19) with a two-dimensional transmission function, for purposes of forming a modulated sample beam (79), which has a modulated intensity distribution (82),
wherein the transmission function has at least one passage region (21) with a substantially constant first intensity transmission factor, and has at least one blocking region (25) with a substantially constant second intensity transmission factor,
wherein the second intensity transmission factor is at most 50% of the first intensity transmission factor,
wherein the transmission function along a first lateral direction (31) comprises at least two contrast steps (32, 33) in the form of transitions between the at least one blocking region (25) and the at least one passage region (21),
wherein the contrast steps (32, 33) are a distance k apart from each other along the first lateral direction (31),
wherein the term “lateral” refers to directions in planes at right angles to the respective local optical axis (11),
is set up to guide the modulated sample beam (79) along a propagation path onto the detector (40) for purposes of forming an intensity distribution (83) on the detector (40) with at least two contrast features (92, 93) along the first lateral direction (31),
wherein the contrast features (92, 93) in the intensity distribution (83) on the detector (40) are formed from the at least two contrast steps (32, 33) in the modulated intensity distribution (82) by means of beam propagation of the modulated sample beam (79) to the detector (40);
wherein the detector (40)
comprises a light radiation-sensitive sensor, resolving spatially in two dimensions, which is set up to convert the intensity distribution (83) impinging on the detector (40) into electrical signals, and
is arranged along the propagation path at a distance s behind the modulation plane (19); and
wherein the evaluation device (45)
is set up to process the electrical signals of the detector (40), which represent the intensity distribution (83) on the detector (40),
is set up to determine a distance a along the first lateral direction (31) between the two contrast features (92, 93) on the detector (40), and
is set up to determine the axial position of the beam focus (71) based on the distance a, and/or to determine an alteration of the axial position of the beam focus (71), based on an alteration of the distance a.

2. The beam analysis device (10) according to claim 1, wherein
at each of the at least two contrast steps (32, 33), in each case a section of the passage region (21) extends along the first lateral direction (31) over a width b, and in each case a section of the blocking region (25) extends along the first lateral direction (31) over a width p.

3. The beam analysis device (10) according to claim 2, wherein
the width b of the sections of the passage region 21 is at least 1.5 times the width p of the sections of the blocking region 25.

4. The beam analysis device (10) according to claim 2, wherein
the sections of the passage region (21) and the sections of the blocking region (25) at the contrast steps (32, 33) extend in a second lateral direction (37), which is oriented at right angles to the first lateral direction (31), over at least a width h.

5. The beam analysis device (10) according to claim 4, wherein
the width h is at least 2 times the width p.

6. The beam analysis device (10) according to claim 1, wherein
the contrast steps (32, 33) are designed as lines, whose tangents at the points of intersection with the first lateral direction (31) are aligned at right angles to the first lateral direction (31).

7. The beam analysis device (10) according to claim 1, wherein
the contrast steps (32, 33) are designed as straight lines that are aligned at right angles to the first lateral direction (31).

8. The beam analysis device (10) according to claim 1, wherein
the first lateral direction (31) and the local optical axis (11) between the modulation plane (19) and the detector (40) are altered by beam folding and/or beam redirection.

9. The beam analysis device (10) according to claim 1, comprising a decoupling device (14), wherein
the decoupling device (14) comprises a beam decoupler (15) for purposes of decoupling the sample beam (70) from the energy beam (77).

10. The beam analysis device (10) according to claim 9, wherein
the beam decoupler (15) is a beam splitter device, which is set up to decouple a radiation component in the range from 0.01% to 5% of the energy beam (77) as a sample beam (70), by reflection and/or transmission.

11. The beam analysis device (10) according to claim 1, wherein
the beam-shaping device (12) comprises an imaging device (50) with at least one optical lens (51) for purposes of guiding the modulated sample beam (79) onto the detector (40).

12. The beam analysis device (10) according to claim 11, wherein
the modulation plane (19) is arranged at the image-side focal point of the imaging device (50).

13. The beam analysis device (10) according to claim 12, wherein
the evaluation device (45) is set up to determine the axial position of the beam focus (71), based on the distance a of the contrast features (92, 93), and/or the alteration of the axial position of the beam focus (71), based on the alteration of the distance a between the contrast features (92, 93), by means of a linear calculation rule.

14. The beam analysis device (10) according to claim 1, wherein
the evaluation device (45) is set up to determine the axial position of the beam focus (71), based on the distance a between the contrast features (92, 93), and/or the alteration of the axial position of the beam focus (71) based on the alteration of the distance a between the contrast features (92, 93), by means of a calculation rule that is linear in at least some sections.

15. The beam analysis device (10) according to claim 1, comprising a beam-folding device (60), which includes a beam splitter (61) and at least one mirror (64), and which is arranged in the beam path in front of the detector (40), wherein
the at least one mirror (64) is arranged to reflect a radiation component leaving the beam splitter (61) back into the beam splitter (61), in this manner forming a first folded beam path, and wherein
the modulation plane (19) is arranged in the beam path in front of the beam-folding device (60), or in the first folded beam path.

16. The beam analysis device (10) according to claim 15, wherein
the beam-folding device (60) additionally includes at least one second mirror (64, 65), wherein
the second mirror (64, 65) is arranged to reflect a further radiation component leaving the beam splitter (61) back into the beam splitter (61), in this manner forming a second folded beam path.

17. The beam analysis device (10) according to claim 16, wherein
the modulation plane (19) of the beam-shaping device (12) is arranged in the first folded beam path, wherein
no modulation is arranged in the second folded beam path for purposes of guiding a radiation component of the sample beam (70) or the energy beam (77) as an unmodulated beam (78) onto the detector (40), and wherein
the evaluation device (45) is set up to determine a beam diameter and/or a beam profile from an intensity distribution of a beam spot (98) of the unmodulated beam (78) on the detector (40).

18. The beam analysis device (10) according to claim 17, wherein
the mirror (64, 65) is arranged such that it can be axially shifted in the second folded beam path and the position of the mirror (64, 65) can be adjusted by means of a positioning device (66).

19. The beam analysis device (10) according to claim 1, wherein
the evaluation device (45) is furthermore set up to determine a lateral position of the entire intensity distribution (83) on the detector (40), and is set up to calculate a lateral position of the beam focus (71) of the sample beam (70) from the lateral position of the entire intensity distribution (83), and/or to calculate an alteration of the lateral position of the beam focus (71) of the sample beam (70) from an alteration of the lateral position of the entire intensity distribution (83).

20. The beam analysis device (10) according to claim 11, additionally comprising a beam splitter (62) for purposes of splitting the sample beam (70), a further imaging device (63) with at least one optical lens, and a second detector (42),
wherein the beam splitter (62) is arranged in the beam path in front of the modulation plane (19),
wherein the beam splitter (62) is arranged between the optical lens (51) of the imaging device (50) and the modulation plane, and
wherein the further imaging means (63) is arranged between the beam splitter (62) and the second detector (42) for purposes of imaging an enlarged beam spot (98), or an enlarged image of the beam focus (71), onto the second detector (42).

21. The beam analysis device (10) according to claim 20, wherein
the evaluation device (45) is set up to process the electrical signals generated by the second detector (42), and wherein
the evaluation device (45) is set up to determine a beam diameter, and/or a focal diameter, from an intensity distribution on the second detector (42).

22. The beam analysis device (10) according to claim 11, additionally comprising a beam splitter (62) for purposes of splitting the sample beam (70), a further imaging device (67) with at least one optical lens, and a second detector (42),
wherein the beam splitter (62) is arranged in the beam path in front of the modulation plane (19),
wherein the beam splitter (62) is arranged between the optical lens (51) of the imaging device (50) and the modulation plane (19),
wherein the further imaging device (67) is arranged between the beam splitter (62) and the second detector (42),
wherein the imaging device (50) and the further imaging device (67) together form a combined lens system, which has an image-side focal plane, and
wherein the second detector (42) is arranged in the image-side focal plane of the combined lens system.

23. The beam analysis device (10) according to claim 22, wherein
the evaluation device (45) is set up to process the electrical signals generated by the second detector (42), and wherein
the evaluation device (45) is set up to determine a divergence angle from an intensity distribution on the second detector (42).

24. A system comprising a beam analysis device (10) according to claim 1, and processing optics (100) for purposes of guiding and focusing the energy beam (77), wherein
the processing optics (100) comprise a decoupling device (14) for purposes of decoupling the sample beam (70) from the energy beam (77), and wherein
the beam analysis device (10) can be connected to the processing optics (100) for purposes of receiving the decoupled sample beam (70).

25. A method for determining an axial position of a beam focus (71), wherein
the beam focus (71) is a focus (76) of an energy beam (77) of electromagnetic radiation, or a focus of a sample beam (70) decoupled from the energy beam (77), comprising the following steps:
modulation of an intensity distribution (81) of the energy beam (77), or the sample beam (70) decoupled from the energy beam (77), in a modulation plane (19) with a two-dimensional transmission function for purposes of forming a modulated sample beam (79) that has a modulated intensity distribution (82), wherein
the transmission function has at least one passage region (21) with a substantially constant first intensity transmission factor, and at least one blocking region (25) with a substantially constant second intensity transmission factor, wherein
the second intensity transmission factor is at most 50% of the first intensity transmission factor, wherein
the transmission function along a first lateral direction (31) comprises at least two contrast steps (32, 33) in the form of transitions from the at least one blocking region (25) to the at least one passage region (21), wherein
the contrast steps (32, 33) are a distance k apart from each other along the first lateral direction (31), wherein
the term “lateral” refers to directions in planes at right angles to the respective local optical axis (11),
guidance of the modulated sample beam (79) onto a detector (40), which is arranged along a propagation path for the modulated sample beam (79) at a distance s behind the modulation plane (19), for purposes of forming an intensity distribution (83) on the detector (40) with at least two contrast features (92, 93) along the first lateral direction (31), wherein
the contrast features (92, 93) in the intensity distribution (83) on the detector (40) are formed from the at least two contrast steps (32, 33) in the modulated intensity distribution (82) by beam propagation of the modulated sample beam (79) to the detector (40),
conversion of the intensity distribution (83) impinging onto the detector (40) into electrical signals by means of a light radiation-sensitive sensor of the detector (40), resolving spatially in two dimensions,
processing of the electrical signals of the detector (40), which represent the intensity distribution (83) on the detector (40),
determination of a distance a along the first lateral direction (31) between the contrast features (92, 93),
determination of the axial position of the beam focus (71), based on the distance a, or determination of an alteration of the axial position of the beam focus (71), based on an alteration of the distance a.

26. The method according to claim 25, comprising a decoupling of the sample beam (70) from the energy beam (77).

27. The method according to claim 26, wherein
by reflection and/or transmission a radiation component in the range from 0.01% to 5% of the energy beam (77) is decoupled as a sample beam (70).

28. The method according to claim 25, wherein
the guidance of the modulated sample beam (79) onto the detector (40) takes place by means of an imaging device (50) with at least one optical lens (51).

29. The method according to claim 28, wherein
the modulation of the intensity distribution (81) takes place at the image-side focal point of the imaging device (50).

30. The method according to claim 29, wherein
the determination of the axial position of the beam focus (71), based on the distance a between the contrast features (92, 93), or the alteration of the axial position of the beam focus (71) based on the alteration of the distance a between the contrast features (92, 93), takes place by means of a linear calculation rule.

31. The method according to claim 25, wherein
the determination of the axial position of the beam focus (71), based on the distance a between the contrast features (92, 93), or the alteration of the axial position of the beam focus (71) based on the alteration of the distance a between the contrast features (92, 93), takes place by means of a calculation rule that is linear in at least some sections.

32. The method according to claim 25, wherein
by means of a beam-folding device (60), which includes a beam splitter (61) and at least one mirror (64), and which is arranged in the beam path in front of the detector (40), a first folded beam path is formed by reflection of a radiation component leaving the beam splitter (61) at the at least one mirror (64) back into the beam splitter (61), and wherein
the modulation of the intensity distribution (81) in the beam path takes place in front of the beam-folding device (60), or in the first folded beam path.

33. The method according to claim 32, wherein
by means of the beam-folding device (60), which additionally contains at least one second mirror (64, 65), a second folded beam path is formed by reflection of a further radiation component leaving the beam splitter (61) at the second mirror (64, 65) back into the beam splitter (61).

34. The method according to claim 33, wherein
the modulation of the intensity distribution (81) takes place in the first folded beam path, wherein
no modulation of an intensity distribution takes place in the second folded beam path, and a radiation portion is guided onto the detector (40) as an unmodulated beam (78), and wherein
a beam diameter and/or a beam profile is determined from an intensity distribution of a beam spot (98) of the unmodulated beam (78) on the detector (40).

35. The method according to claim 34, wherein
by means of a positioning device (66) the axial position of the mirror (64, 65) in the second beam path is varied, and for at least three different positions of the mirror (64, an intensity distribution of the beam spot (98) of the unmodulated beam (78) is in each case registered on the detector (40), and wherein
from the registered intensity distributions at least one beam parameter of the sample beam (70) is determined.

36. The method according to claim 25, comprising the determination of a lateral position of the entire intensity distribution (83) on the detector (40), and the calculation of a lateral position of the beam focus (71) of the sample beam (70) from the lateral position of the entire intensity distribution (83), or the calculation of an alteration of the lateral position of the beam focus (71) of the sample beam (70) from an alteration of the lateral position of the entire intensity distribution (83).

37. The method according to claim 28, comprising the following steps:
splitting the sample beam (70) by means of a beam splitter (62), which is arranged in the beam path behind the optical lens (51) of the imaging device (50) and in front of the modulation plane (19),
imaging of a split-off sample beam onto a second detector (42) by means of a further imaging device (63) with at least one optical lens arranged between the beam splitter (62) and the second detector (42), for purposes of forming an enlarged beam spot (98), or an enlarged image of the beam focus (71), on the second detector (42), and
determination of a beam diameter or a focal diameter from an intensity distribution on the second detector (42).

38. The method according to claim 28, comprising the following steps:
splitting the sample beam (70) by means of a beam splitter (62). which is arranged in the beam path behind the optical lens (51) of the imaging device (50) and in front of the modulation plane (19),
guidance of a split-off sample beam onto a second detector (42) by means of a further imaging device (67), with at least one optical lens arranged between the beam splitter (62) and the second detector (42), for purposes of forming a far-field beam distribution (99) on the second detector (42), wherein the imaging device (50) and the further imaging device (67) together form a combined lens system, which has an image-side focal plane, and wherein the second detector (42) is arranged in the image-side focal plane of the combined lens system, and
determination of a far-field beam diameter or a divergence angle from an intensity distribution on the second detector (42).

39. The method according to claim 25, wherein
the energy beam (77) is focused by processing optics (100).

40. The method according to claim 39, wherein
the determined axial position of the beam focus (71), or the determined alteration of the axial position of the beam focus (71), is used to control a laser processing operation.
